(19) United States
(12) Patent Application Publication
(10) Pub. No.: US 2012/0243230 A1
(43) Pub. Date: Sep. 27, 2012

(54) HEAT TRANSFER ASSEMBLY FOR LED-BASED LIGHT BULB OR LAMP DEVICE

(75) Inventors: David W. Carroll, Grantsburg, WI (US); Wendell Carroll, Minneapolis, MN (US); Terry Travis, Nerstrand, MN (US)

(73) Assignee: FOREVER BULB, LLC, Grantsburg, WI (US)

(21) Appl. No.: 13/429,059

(22) Filed: Mar. 23, 2012

Related U.S. Application Data
(60) Provisional application No. 61/466,715, filed on Mar. 23, 2011.
(60) Provisional application No. 61/545,904, filed on Oct. 11, 2011.

(51) Int. Cl. F21V 29/00

(52) U.S. Cl. 362/249.02

(57) ABSTRACT

A LED-based light bulb or lamp device including a bulb body, an LED assembly, an LED heatsink, and a power conversion heatsink. The LED assembly includes a plurality of LEDs and circuitry. The circuitry includes power converting components adapted to modify applied power for powering the LEDs via conductive wiring. The LED heatsink is mounted to the bulb body in close proximity to at least one of the LEDs. The power conversion heatsink is provided apart from the LED heatsink and is mounted to the bulb body in close proximity to at least one of the power converting components. The LED heatsink dissipates heat from at least some of the light emitting diode lights whereas the separate power conversion heatsink dissipates heat from the power converting circuitry components, thereby separating the heat-generating components and their mounting zones, heat paths and heatsink surface areas.

### CROSS-REFERENCE TO RELATED APPLICATIONS

This application claims priority under 35 U.S.C. §119(e)(1) to U.S. Provisional Patent Application Ser. No. 61/466,715, filed Mar. 23, 2011, entitled “LED-Based Light Bulb Device with Fitted Driver Circuitry”, and bearing Attorney Docket No. F1043.103.101 and U.S. Provisional Patent Application Ser. No. 61/545,904, filed Oct. 11, 2011, entitled “Heat Transfer Assembly for LED-Based Light Bulb or Lamp Device”, and bearing Attorney Docket No. F1043.107.101; and the entire teachings of each of which are incorporated herein by reference.

### BACKGROUND

The present disclosure relates to light emitting diode (LED) illuminating devices and methods, and more particularly, to LED-based lighting device heat transfer assembly solutions in a format akin to a common incandescent light bulb or lamp. As a point of reference, the terms “bulb” and “lamp” are used interchangeably throughout this specification.

Incandescent light bulb or lamp replacement solutions, such as compact fluorescent lights (CFLs) and LED bulbs, are becoming more widely used as the cost of energy increases. Unfortunately, aesthetic concerns exist for the “tubes” of the CFL format, and unusual shapes of current LED environmental solutions. Consumers and commercial concerns have existing fixtures or sockets that in many cases look unappealing with these new replacement bulb offerings. In many cases, consumers avoid doing what is environmentally and financially correct to maintain the appearance of the common incandescent bulb.

LED-based lights provide the longest lasting, and over time the lowest cost and most environmentally-friendly, solution for lighting. Two major problems have been the high initial cost per lumen and the directionality of the light emitted by LED bulbs. More recently, greatly improved LED-based bulb devices have been developed, arranging a number of individual LEDs along a bulb structure otherwise highly similar in appearance to a conventional incandescent light bulb. Several highly promising bulb devices incorporating this format are described in U.S. Pat. No. 8,013,501, the entire teachings of which are incorporated herein by reference. With these and similar designs, the bulb device is intended to be used with a conventional incandescent light bulb fixture or socket (delivering AC power from a power source). Thus, the bulb device must carry or include appropriate circuitry that converts the AC power at the fixture or socket to power appropriate for powering or driving the LEDs. The power converting circuitry components, in turn, generate heat that must be dissipated for long-term operation. The LEDs themselves also generate heat that must be removed. In this regard, the small size of the LED die emits substantial heat per unit area from the back of the LED package. LED bulb or lamp designs typically use a heatsink to transfer this heat to surrounding ambient air.

LED light bulb designs involve a complex set of tradeoffs between the selection of and numbers of LED components, LED drive parameters, system thermal constraints, system lifetime and performance targets. All of these tradeoffs are made within limits of cost goals and a desire to approximate the appearance of a conventional incandescent bulb. Implementation difficulty increases with the luminosity outputs requirements of high watt equivalency solutions.

Design of power conversion systems to meet light output targets of 60 W, 75 W, 100 W equivalency will be increasingly challenging, requiring careful selection of components, circuit board design and thermal design. Dissipation of system heat from both the conversion electronics and the LEDs is particularly challenging. Internally mounted LEDs and power conversion components must be mounted on substrates providing thermal paths where heat is conducted to external surfaces for convective dissipation. Any solution must be careful that heat generated from one set of components does not inadvertently conduct to and contribute to the temperature rise of others, raising temperatures of individual components above their operational limits.

A related heat transfer issue in the realm of LED-based light bulb design is the heat transfer paths and surface systems. Any acceptable design must transmit the heat in a manner that also avoids electronic hazard paths. Regulatory compliance safety testing includes subjecting the lamp to a series of very high transient voltages and confirming that the lamp design does not allow such events to reach human accessible surfaces in such a way as to pose a safety issue to users.

LED-based light bulb designs give rise to multiple heat transfer-related concerns. Any resolution of these problems will be well-received.

### SUMMARY

Some aspects of the present disclosure related to a LED light bulb or lamp device including a bulb body, an LED assembly, an LED heatsink, and a power conversion heatsink. The LED assembly includes a plurality of light emitting diode lights and circuitry. The circuitry includes power converting components adapted to modify applied power for powering the light emitting diode lights via conductive wiring. The LED heatsink is mounted to the bulb body in close proximity to at least one of the light emitting diode lights. The power conversion heatsink is provided apart from the LED heatsink and is mounted to the bulb body in close proximity to at least one of the power converting components. With the above construction, the LED heatsink dissipates heat from at least some of the light emitting diode lights whereas the separate power conversion heatsink dissipates heat from the power converting circuitry components, thereby separating the heat-generating components and their mounting zones, heat paths and heatsink surface areas. In some embodiments, filtering components of the circuitry are mounted to a first or filter substrate or circuit board whereas the power converting components are mounted to a second or power converting substrate or circuit board. Though electrically connected, the boards are physically separated from one another within a base portion of the device, with the power converting board being located in close proximity to, and in some embodiments physically contacting, the power conversion heat sink. In other embodiments, the power converting heatsink is a ring, with the device configured such that the heatsink ring facilitates assembly of the bulb body with the base. In related configurations, the heatsink ring can be located in close proximity to the device's socket connection base but electrically protected from the base, for example by an intervening dielectric material.

### BRIEF DESCRIPTION OF THE DRAWINGS

FIG. 1 is a perspective view of an LED-based light bulb device in accordance with principles of the present disclosure;

FIG. 2 is a perspective, exploded view of the device of FIG. 1;

FIG. 3 is a longitudinal cross-sectional view of the device of FIG. 1;

FIG. 4 is an enlarged perspective view of a bulb body portion of the device of FIG. 1;

FIG. 5 is an enlarged longitudinal cross-sectional view of a portion of the device of FIG. 1 and illustrating features not visible in the cross-section of FIG. 3;

FIG. 6A is a lateral cross-sectional view of the device of FIG. 1, illustrating optional arrangements of LEDs relative to the bulb body portion;

FIG. 6B is a lateral cross-sectional view of another LED-based light bulb device in accordance with principles of the present disclosure;

FIG. 7 is a side view of another LED-based light bulb device in accordance with principles of the present disclosure;

FIG. 8A is a perspective view of the device of FIG. 7 at a different rotational orientation;

FIG. 8B is the view of FIG. 8A with portions removed to illustrate internal components of the device;

FIG. 9 is a cross-sectional illustration of a portion of the bulb device of FIG. 7;

FIG. 10 is a perspective view of another LED-based light bulb device in accordance with principles of the present disclosure;

FIG. 11 is an exploded perspective view of the bulb device of FIGS. 10; and

FIG. 12 is a cross-sectional illustration of a portion of the bulb device of FIG. 10.

### DETAILED DESCRIPTION

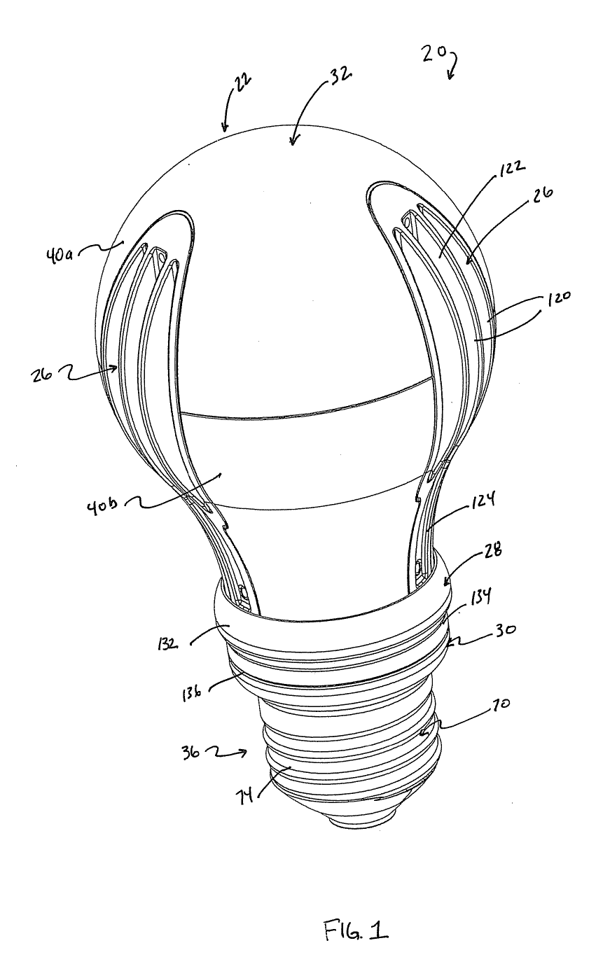

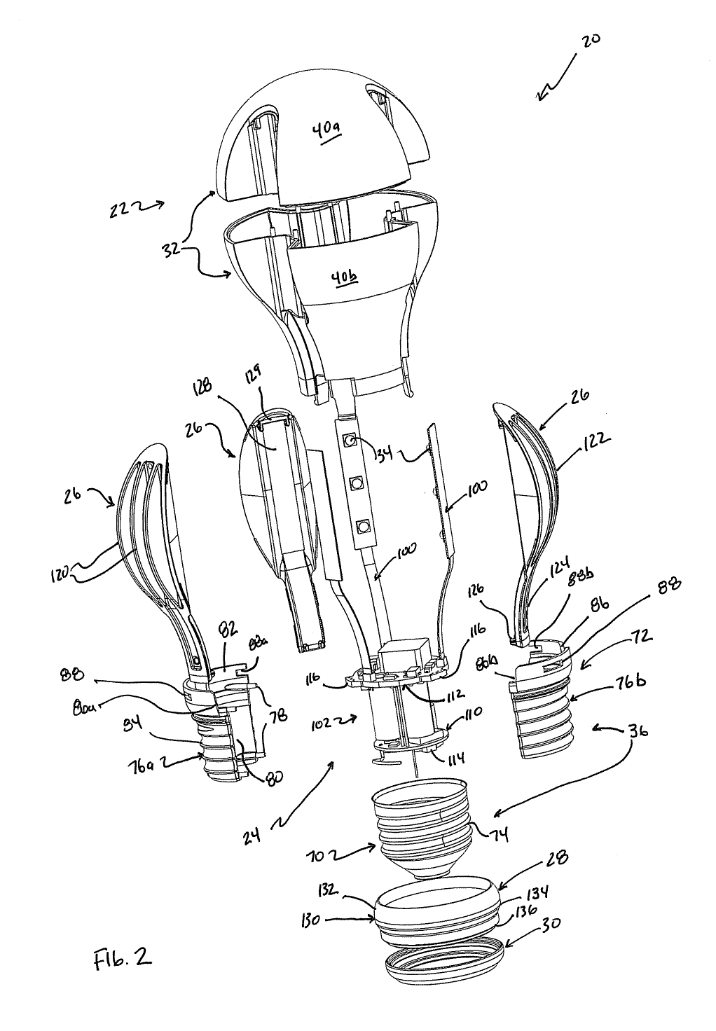

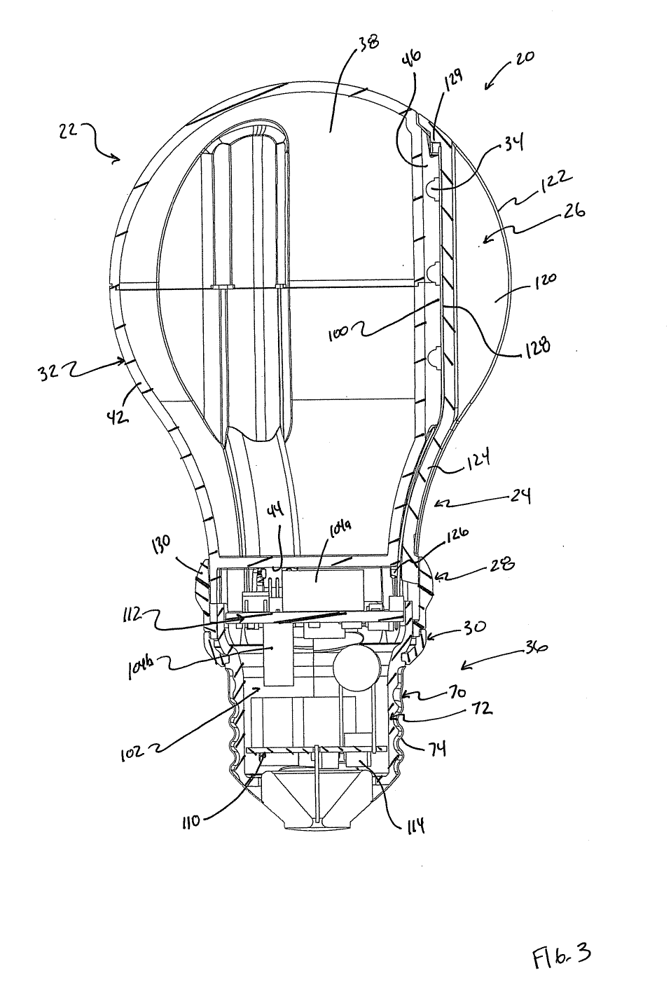

One embodiment of an LED light bulb device 20 in accordance with principles of the present disclosure is shown in FIGS. 1-3. The device 20 includes a light bulb-like structure 22, an LED assembly 24 (hidden in FIG. 1 and referenced generally in FIGS. 2 and 3), one or more LED heatsinks 26, a power conversion heatsink 28, and an insulator sleeve 30. Details on the various components are provided below. In general terms, however, the light bulb-like structure 22 includes a bulb body 32, and the LED assembly 24 provides one or more light emitting diodes (LEDs) 34 (identified in FIGS. 2 and 3, it being understood that in the final construction state of FIG. 1, the LEDs 34 may be visible “through” the bulb body 32). The LED assembly 24 is mounted to the light bulb-like structure 22. The LED heatsink(s) 26 and the power conversion heatsink 28 collectively define a heat transfer assembly for the device 20. The LED heatsink(s) 26 transfer and dissipate heat generated by the LEDs 34, whereas the power conversion heatsink 28 transfers and dissipates heat generated by other high operational temperature components (e.g., power conversion electrical components) of the LED assembly 24 as described below. The LED heatsinks 26 are generally separated from the power conversion heatsink 28 by a thermally insulative layer. The LED light bulb device 20 emits light when connected to, and energized by, a standard light bulb socket or fixture.

The light bulb-like structure 22 is akin to a “standard” or known AC bulb (e.g., an Edison incandescent light bulb) and includes the bulb body 32 and a base assembly 36. The bulb body 32 can be formed of glass, plastic (e.g., clear glass or plastic), etc., and defining an open interior region 38 (best shown in FIG. 3). The bulb body 32 can have various shapes and sizes (e.g., pear shape (A19), rounded globe, pyramidal (flood light) candle-shaped, etc.), as well as other optional features that allow a more integrated appearance of the mounted LED heatsink(s) 26.

In some embodiments, for ease of manufacture, the bulb body 32 can be formed by two (or more) segments 40a, 40b that are separately formed and subsequently assembled (e.g., a snap-fit construction as implied by the view of FIG. 2). Alternatively, the bulb body 32 can be an integral, homogeneous structure.

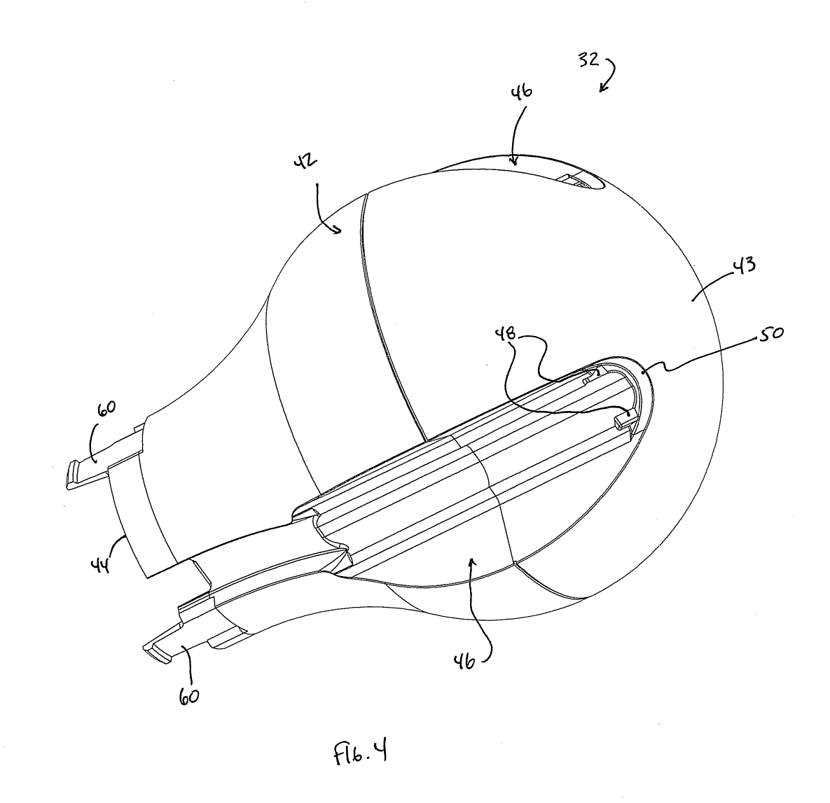

The bulb body 32 is shown in greater detail in FIG. 4. Regardless of the number of segments utilized to generate the bulb body 32, upon final construction the bulb body 32 can be viewed as having a bulb body wall 42 that defines the interior region 38 (FIG. 3). In some embodiments, the wall 42 is a continuous structure, extending from a closed top end 43 to an open lower end 44 that is otherwise open to the interior region 38. Thus, the wall 42 effectively encloses the interior region 38.

FIG. 4 further illustrates the wall 42 as forming slots 46 each shaped and sized to receive a respective one of the LED heatsinks 26. The slots 46 can be closed relative to the interior region 38 (FIG. 3) as shown. Alternatively, the slots 46 can be formed through a thickness of wall 42 and thus are open to the interior region 38 as described below. The bulb body 32 can form or include latches 48 (or a similar structure such as a fastener, catch or adhesive) at or adjacent a top end 50 of each slot 46 for receiving a corresponding component of one of the LED heatsinks 26. The slots 46 can assume a variety of other forms differing from the format illustrated in FIG. 4, and can include various surface features configured to mate with components of the LED heatsinks 26 and/or of the LED assembly 24.

The bulb body 32 can include or provide one or more features that facilitate rapid assembly to other components of the device 20. For example, a plurality of locking fingers 60 are shown in FIG. 4 as extending in a generally longitudinal fashion from the open end 44. As described below, the locking fingers 60 are configured for snap fit-type assembly with a corresponding surface feature of the power conversion heatsink 28. Other mounting features can be employed with alternative embodiments envisioned by the present application that may or may not employ a snap fit (e.g., the bulb body 32 can be bonded or welded to the paver conversion heatsink 28 and/or the base assembly 36 with the locking fingers 60 omitted).

Returning to FIGS. 1-3, the base assembly 36 includes an exterior base 70 and an optional isolation housing 72 (referenced generally in FIG. 2). The exterior base 70 is akin to a conventional light bulb base, and has a threaded exterior surface 74 for engaging a standard threaded AC light socket or fixture to hold and power the LED light bulb device 20 to the AC light socket or fixture as is known in the art. Along these same lines, the exterior base 70 is optionally formed from a conductive material (e.g., metal) as is typically employed with conventional light bulbs. The bulb-to-socket connection provided by the exterior base 70 (or other components of the base assembly 36) can be of other types common in the industry. The exterior base 70 (and other components of the base assembly 36) can have various constructions for connection to an AC power socket including, but not limited to, the Edison screw base such as the E26 medium screw base.

Where provided, the isolation housing 72 is configured for partitioning the exterior base 70 from circuitry components of the LED assembly 24 as described below while facilitating thermal transfer of heat to the power conversion heatsink 28. In some embodiments, the housing 72 can be formed by first and second housing portions 76a, 76b each providing a mating feature that promotes mounting of the two housing portions 76a, 76b to one another (e.g., in the view of FIG. 2, the first housing portion 76a is shown as including pegs 78 that are frictionally received by corresponding apertures (not shown) formed by the housing portion 76b). Apart from the mating features, the housing portions 76a, 76b can be identical, with the following descriptions applying equally to each of the housing portions 76a, 76b.

The housing portion 76a, 76b has a semi-annular shape, and defines a foot 80 and a lip 82. An exterior 84 of the foot 80 has a thread-like shape for nesting within the threaded surface 74 of the exterior base 70. The lip 82 extends from the foot 80 and forms clearance notches 86 and passages 88. Each of the clearance notches 86 is sized to receive a respective one of the locking fingers 60 provided with the bulb body 32. As generally reflected by FIG. 2, three of the clearance notches 86 are formed by the housing 72 upon final construction, with each housing portion 76a, 76b defining one complete notch 86 and as well as a section of a second notch (i.e., in FIG. 2, notch section 86a provided with the first housing portion 76a is labeled, as is notch section 86b provide with the second housing portion 76b, it being understood that the notch sections 86a, 86b combining to define a complete one of the notches 86 upon final assembly). More or less of the notches 86, commensurate with the number of locking fingers 60, are equally acceptable in other embodiments. Moreover, with other devices in accordance with the present disclosure that employ different assembly features, the notches 86 can be replaced or omitted.

Each of the passages 88 is sized to receive a structure (e.g., a tab) provide with the LED assembly 24. As generally reflected by FIG. 2, three of the passages 88 are formed by the housing 72 upon final assembly (although any other number, either lesser or greater, is also acceptable), with each housing portion 76a, 76b defining one complete passage 88 as well as a section of a second passage (i.e., in FIG. 2, passage sections 88a, 88b provided with the first and second housing portions 76a, 76b, respectively, are labeled, it being understood that the passage sections 88a, 88b combine to define a complete one of the passages 88 upon final assembly).

With reference to FIG. 2, the LED assembly 24 includes, in some embodiments, a plurality of the LEDs 34, substrate strips 100, and circuitry 102 (referenced generally). The substrate strips 100 each maintain a set of the LEDs 34, and are coupled to the circuitry 102 as described below to establish an electrical pathway for powering of the LEDs 34.

The LEDs 34 can assume a variety of forms known in the art and conventionally employed for inorganic light-emitting diodes. The LEDs 34 can alternatively be organic light-emitting diodes (OLEDs). The selected format of the LEDs 34 may or may not produce white light, and can have various color temperatures (e.g., the LEDs 34 can be high temperature (on the order 6500 Kelvin) products). Further, the packaging associated with the LEDs 34 may or may not incorporate color or Kelvin-modifying materials such as phosphor, quantum dots, nanocrystals, nano-fiber, and/or other coatings or layers for enhancing the light emitted by the LEDs 34. The LEDs 34 can be formed or assembled to the corresponding substrate strips 100 in various fashions, including standard packaging, die-on-flex packaging, wafer-layering with sputter coating that permits, for example, non-sapphire based LEDs, etc. The LEDs 34 can be mounted in ceramic packages or other package formats mounted as known-good-die (KGD) or otherwise described above but mounted directly as die to the substrate using variously known methods.

In some constructions, the substrate strips 100 are each a flexible, non-conductive material akin to flex circuits as known in the art, and carry circuitry traces to each of the LEDs 34 formed thereon. Alternatively, a more rigid material can be employed for some or all of the substrate strips 100. For example, the substrate strips 100 can be provided as part of an insulated aluminum material system (IAMS), such as Insulated Aluminum Material System available from Hereaus Materials Technology.

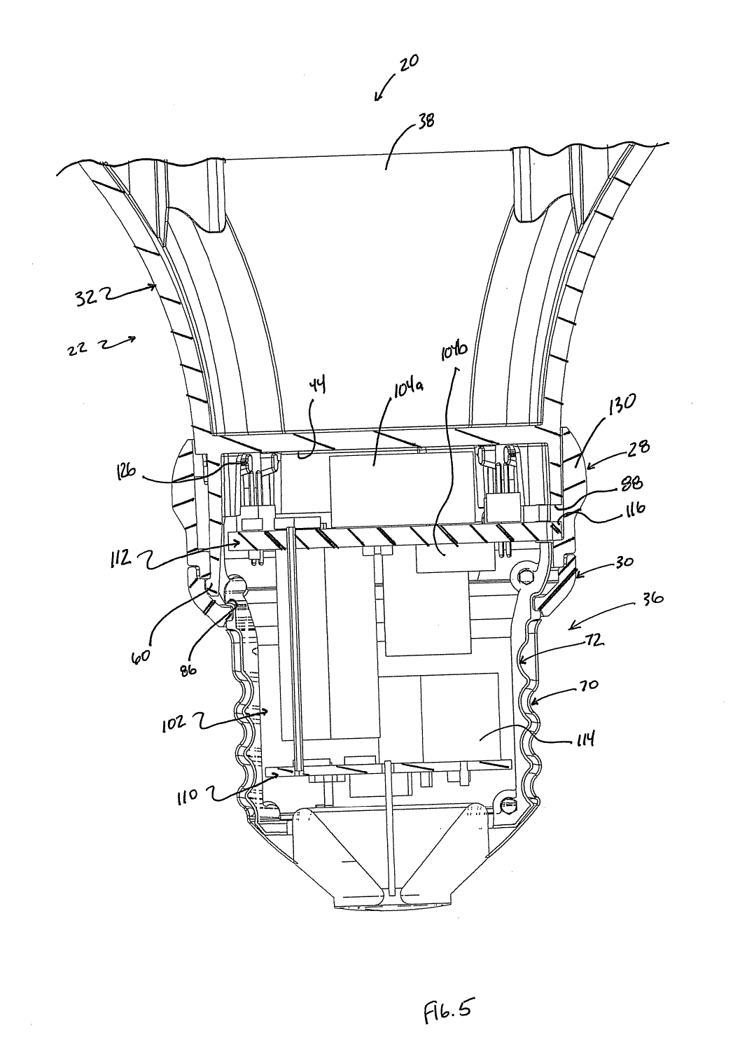

The circuitry 102 can assume a wide variety of forms appropriate for converting AC energy (e.g., 120 volts) to DC energy appropriate for energizing the LEDs 34; or where the LEDs 34 are configured to operate based on an AC power input, the circuitry 102 can incorporate components configured to convert or transform a provided AC power supply to an AC power format appropriate for powering the LEDs 34. Regardless, and as better shown in FIG. 5, the circuitry 102 includes one or more high operating temperature power transforming or converting components 104a, 104b (e.g., MOSFET and inductors).

With the above in mind, in some constructions, the circuitry 102 includes a first or filtering board 110 and a second or power converting board 112. The boards 110, 112 can each be a rigid, flexible, or a mix of rigid and flexible printed circuitry substrate or board having or forming various circuitry traces. Electrical power filtering components 114 (referenced generally) are mounted and electrically connected to the filtering board 110, and are configured to filter delivered power and/or other related functions as known in the art before relaying filtered power to the power converting board 112. Examples of conventional electrical power filtering components include fuses, EMI filters, transient volt suppression, etc. The power converting electrical components 104a, 104b are mounted and electrically connected to the power converting board 112, and are configured to modify AC power to DC power and/or otherwise perform related power modification functions as may be desired or required to drive the LEDs 34 as is known in the art.

The filtering board 110 and the power converting board 112 are sized and shaped for nested assembly within the isolation housing 72 in a spaced apart, physically separated fashion as described below, and can have the circular perimeter shape shown. One or more connector wires electrically connect the filtering board 110 with the power converting board 112, delivering filtered power to the power converting board 112. For example, a hot wire and a neutral wire are also connected to the filtering board 110. The power converting board 112 is configured to be received within the housing 72, and has a generally disc-like shape. In some embodiments, the power converting board 112 is thermally conductive, and forms one or more tabs 116 (two of which are identified in FIG. 2). The tabs 116 are each sized and shaped to be received through a corresponding one of the passages 88 provided with the housing 72 for reasons made clear below. Finally, the substrate strips 100 are mounted to and extend from the power converting board 112, with the circuitry trace(s) provided with each of the substrate strips 100 being electrically connected to the outputted power of the power converting circuitry (e.g., the substrate strips 100 can be integrated into the optionally more rigid board 112 and/or supported by a tab provided with the board 112).

Returning to FIGS. 1-3, the LED heatsinks 26 are configured to dissipate heat from corresponding ones of the LEDs 34, and to support corresponding ones of the substrate strips 100 relative to the bulb body 32. The number of LED heatsinks 26 corresponds with the number of substrate strips 100; thus, in the one example shown, three substrates strips 100 are provided, and thus three of the LED heatsinks 26 are included. Any other number, greater or lesser than three, is also acceptable. The LED heatsinks 26 can be identical in terms of material and design, and can be formed of an appropriate heatsink material (e.g., metal, molded plastic, ceramic, etc.). Each of the LED heatsinks 26 can incorporate or form fins 120 or pegs (not shown) and/or have other surface features (e.g., shaped channels) that promote heat dissipation. The LED heatsink 26 can be shaped to define a shoulder 122 and an arm 124. A bulk or majority (e.g., greater than 75%) of the LED heatsink 26 mass is located at the shoulder 122, with the arm 124 extending from the shoulder 122 and terminating at a clip end 126. In some embodiments, an interior face 128 (identified for one of the heatsinks 26 in FIGS. 2 and 3) is relatively flat for receiving the corresponding substrate strip 100 (e.g., a pressure sensitive adhesive bonds the substrate strip 100 to the interior face 128), and can be formed as part of a trough as shown. In other embodiments, an entirety of the interior face 128 can be flat or can have other shapes or surface features. In yet other configurations, the electrical connection between the LEDs 34 and the circuitry 102 can pass behind a surface of the bulb body 32. Regardless, a mounting frame 129 is optionally provided at a leading end of the interior face 128.

The power conversion heatsink 28 is separate from the LED heatsinks 26, and is made of an appropriate heat sink material (e.g., metal, molded plastic, ceramic, etc.). In some embodiments, the power conversion heatsink 28 is or includes a ring 130 shaped for assembly to the bulb-like structure 22. More particularly, the annular shape of a leading region 132 of the power conversion heatsink ring 130 is sized to nest about a corresponding exterior region of the bulb body 32, creating a streamlined overall appearance and permitting the lighted surface area to “look” more like common incandescent bulb (as compared to other available LED-based light bulb designs). A trailing region 134 terminates at a ridge 136 sized to receive the insulator sleeve 30 and to mate with the locking fingers 60 upon final assembly. Alternatively, the power conversion heatsink 28 can have a variety of different constructions that includes one or more structures in addition to the ring 130.

The insulator sleeve 30 is formed of an electrically non-conductive material, and is configured for mounting to the power conversion heatsink 28. In particular, the sleeve 30 includes various surface features for promoting a frictional lock over the ridge 136. As described below, the sleeve 30 electrically isolates the power conversion heatsink 28 from the exterior base 70. Alternatively, the insulator sleeve 30 can be replaced with an electrically insulative material coated onto the power conversion heatsink 20.

FIGS. 3 and 5 illustrate the LED light bulb device 20 upon final assembly. In general terms, the housing 72 encloses portions of the circuitry 102 below or relative to the power converting board 112, and at least a portion of the housing 72 (e.g., the foot 80 (FIG. 2)) is mounted within the exterior base 70. With additional reference to FIG. 2, the fingers 116 provided by the power converting board 112 project through respective ones of the housing passages 88. The power conversion heatsink 28 is, in turn, mounted over the housing 72 (e.g., via an adhesive sealant and/or interlocking features) in the location shown. Upon final assembly, the power conversion heatsink 28 contacts the protruding tabs 116. The substrate strips 100 (or corresponding electrically conductive tab surfaces) extend from the power converting board 112 and along and/or beyond the bulb body 32. In this regard, a heat dissipation layer can be assembled to respective ones of the substrate strips 100 (e.g., via a pressure sensitive adhesive) or tab surfaces to become adjacent to the power conversion heatsink 28. Regardless, the high operating temperature power transforming or converting components 104a, 104b are located immediately adjacent the power converting board 112, and thus in close proximity to the power conversion heatsink 28. Thermal heat at the power converting board 112 is effectively directly conducted to the power conversion heatsink 28 via the tabs 116 (that are otherwise in contact with the heatsink 28). Thus, the relatively high heat generated during operation of the power converting board 112 and associated power converting components 104a, 104b is readily transferred to, and dissipated by, the power conversion heatsink 28. Remaining components of the circuitry 102 (e.g., the filtering components 114) are strategically located at other locations within or adjacent the housing 72; because these components generate less heat (as compared to the power converting components 104a, 104b), heat dissipation issues, if any, are of minimal concern. Pointedly, the low heat generated by the circuitry components of the filtering board 110 will convect to the exterior base 70 and subsequently dissipate through the fixture socket (and then to air) as with conventional incandescent light bulbs.

The LED heatsinks 26 are located in close proximity to a respective ones of the substrate strips 100 (and thus in close proximity to the LEDs 34 carried thereby), and can be maintained relative to the bulb body 32 in various manners (e.g., the substrate strips 100 are adhesively bonded to the interior surface 128 of the corresponding LED heatsink 26 that in turn is mounted to the bulb body 32). Alternatively, the connection may be made at the bottom of a screen printed circuit on the LED heatsink 26 with directly mounted LEDs and wires, strips or flexible wiring that make the connection to the power conversion circuitry. Regardless, heat generated by the LEDs 34 is readily transferred to, and dissipated by, the corresponding LED heatsink 26. Notably, a bulk or majority of the mass of each LED heatsink 26 (i.e., the shoulder 122) is separated from the power conversion heatsink 28. By physically separating at least a majority of a mass of the LED heatsinks 26 from the power conversion heatsink 28, thermal transfer between the heatsinks 26, 28, if any, is limited.

With some embodiments of the present disclosure, the power conversion heatsink ring 130 further assists in completing assembly of the device 20. In particular, the LED heatsinks 26 are mounted within respective ones of the bulb body slots 46, with the heatsink frame 129 attached to the corresponding bulb body latch 48 and the clip end 126 frictionally captured against the bulb body open end 44. The locking fingers 60 of the bulb body 32, in turn, project through the housing 72 (via the notches 86) and are frictionally captured by (within) the ring 130. Thus, the ring 130 serves to connect the bulb body 32/LED heatsinks 26 with the base assembly 36. While the present disclosure encompasses a variety of other design features and/or assembly techniques, the features of FIG. 2 as described above elegantly promote rapid, mass production of the device 20.

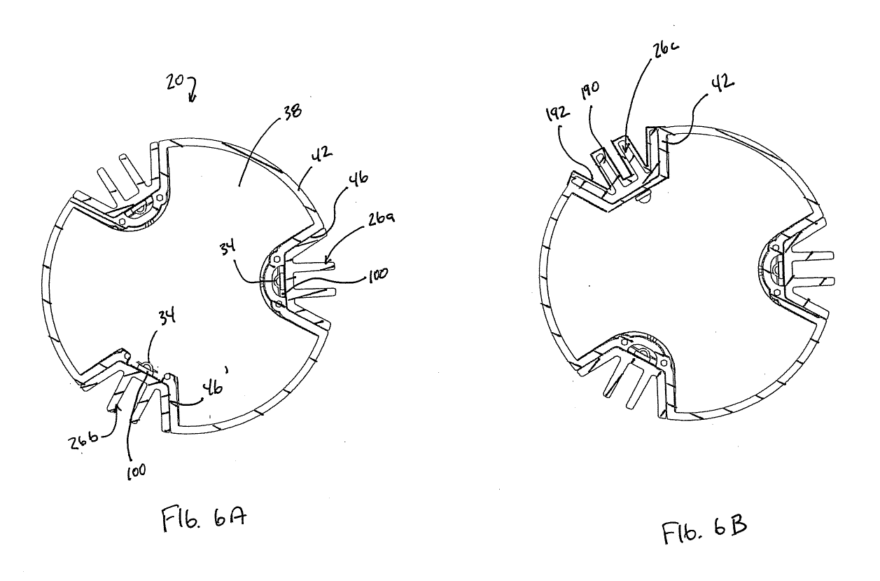

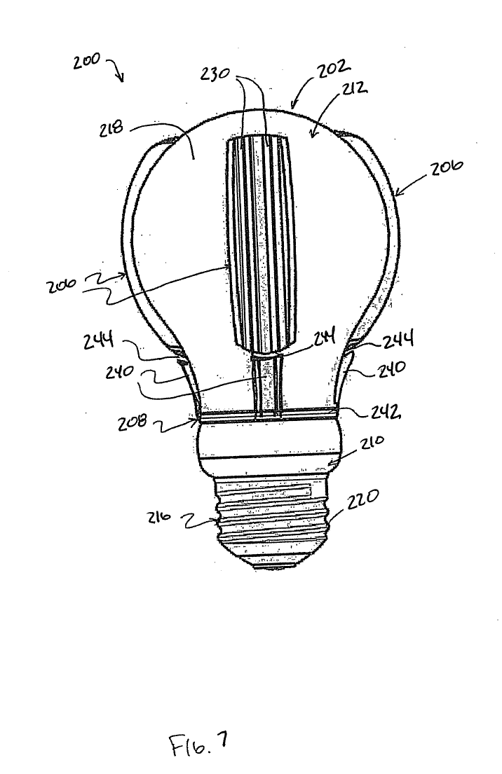

The LEDs 34 are arranged relative to the bulb body 32 so as to direct emitted light toward the bulb body interior region 38. For example, as shown relative to a first one of the LED heatsinks 26a in FIG. 6A, the bulb body wall 42 can form the slot 46 as being closed relative to the interior region 38. The LEDs 34 carried by the corresponding substrate strip 100 and maintained by the first LED heatsink 26a are disposed within the slot 46, with light emitted from the LEDs 34 being directed through the bulb body wall 42 and into the interior region 38. Alternatively, as shown relative to a second one of the LED heatsinks 26b in FIG. 6A, the bulb body wall 42 can form a slot 46′ that is open to the interior region 38. The LEDs 34 carried by the corresponding substrate strip 100 and maintained by the second LED heatsink 26b (or mounted directly to a screen printed circuit on the LED heatsink) are arranged within the slot 46′ so as to direct emitted light into the interior region 38. However, the so-emitted light does not pass through a thickness of the bulb body wall 42 on a pathway into the interior region 38; instead, emitted light transmits directly into the interior region 38. The device 20 can incorporate the closed slot 46 or the open slot 46′ for each of the LED heatsink 26 assembly areas.

Regardless of the bulb body wall 42 construction, and returning to FIGS. 1-3, the heat transfer assembly (e.g., the LED heatsinks 26 and the power conversion heat sink 28) increases surface area, and divides and proportions heatsink areas to keep temperatures within each component's operational limits. As a point of reference, some production LEDs operate fairly efficiently and have a reasonable lifespan at up to 150 degrees C., while some common components used for power conversion are limited to a considerably lower temperature. To address the discrete, but equally important, heat transfer needs, the heat transfer assembly of the present disclosure separates these components and their mounting zones, heat paths and heatsink surface areas.

The separate LED heatsinks 26 effectively “float” along the fattest part of the common bulb body shape 32 and as such the heat convection can: be larger by being located in the widest part of the bulb body 32; be optimal in base-up or base-down orientation because heatsink ribs are vertical an convective air flow is least restricted; improve heat dissipation by dividing the LEDs 34 into groups and spacing them remotely from each other; permit two different levels of heatsink temperatures by isolating the LEDs 34 from power converting parts 104a, 104b with different heat dissipation paths. The stem connection to the LED heatsinks 26 may be connected to or be a direct part of the LED heatsinks 26, or to the power conversion heatsink 28, but not both.

The power conversion heatsink 28 may combine with other components as protection for LED connector wiring. One version of the device 20 of the present disclosure invention places the hottest of the power conversion parts (i.e. MOSFET and inductors) on their own flexible substrate to provide a widened path to specific zones of the power conversion heatsink 28. This may be combined with the LED connector wiring as a separate layer of the flex circuitry 102. This is applied using pressure sensitive adhesive or similar material that permits heat penetration while protecting the circuit from power transfer so the UL high-pot test can be achieved.

In some constructions of the present disclosure, the LEDs 34 can be run at much higher amperage (as compared to amperage levels employed with conventional, LED-based incandescent light bulb replacement devices) and not overheat the power converting components 104a, 104b. It also provides the ability to increase space and spacing for improved convection for all components. It permits the area between heatsinks 26, 28 to increase bulb surface area for lumen uniformity and less lumen per square inch of bulb enclosure area. It further provides segments of the heatsink 26, 28 to more directly cool the hottest components of the power conversion system. For example, the tab or strip conductors to the power conversion heatsink 28 (e.g., the tabs 116) can be orientated to more directly adjoin the hottest components. The bulb devices 20 can be brighter with less LEDs 34 (as compared to conventional designs), providing more lumens in a more normal-to-conventional bulb shape and surface glow area.

The methods and systems described above can be employed using one or more features described in U.S. Publication No. 2011/0242826 entitled “Lightweight Heat Sinks and LED Lamps Employing Same” and the teaching of which are incorporated herein by reference. In applying the separation of the heatsinks features described above, a coated heatsink body which in some embodiments is a plastic heatsink body will apply the described thermally conductive layer disposed over the heatsink body in such a way to cause a gap in the disposed layer, in some cases copper, to provide the separation of heatsinks areas. These heatsink areas are each connected to either the LEDs or power conversion heat sources. Additional heatsink areas may be used as desired for the purpose of individually meeting the requirements of heat dissipation by component part or parts. For example, FIG. 6B illustrates, with respect to a third one of the LED heatsinks 26c, the bulb body wall 42 continuously forming a core 190 of the third LED heatsink 26 and a thermally conductive layer 192 coated or otherwise disposed over the core 190.

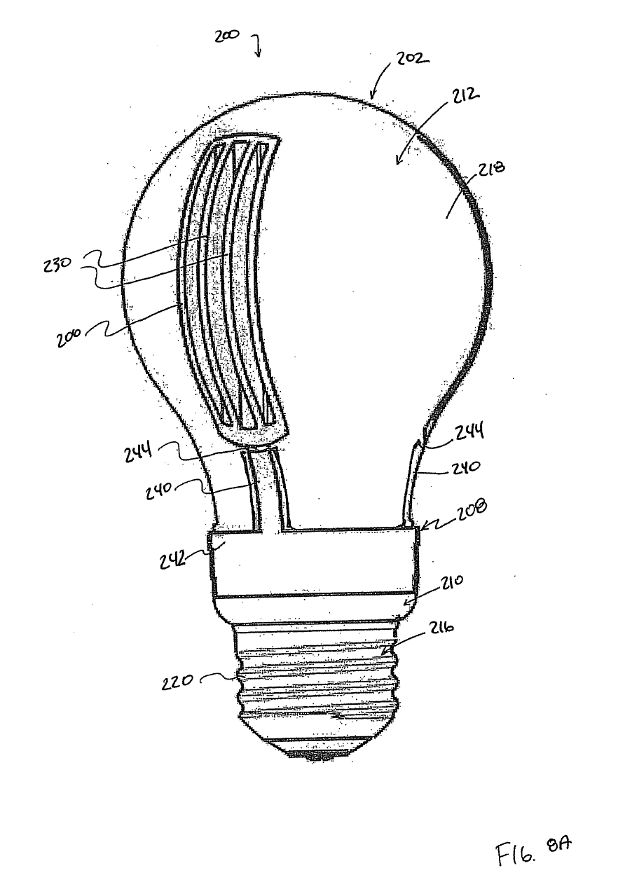

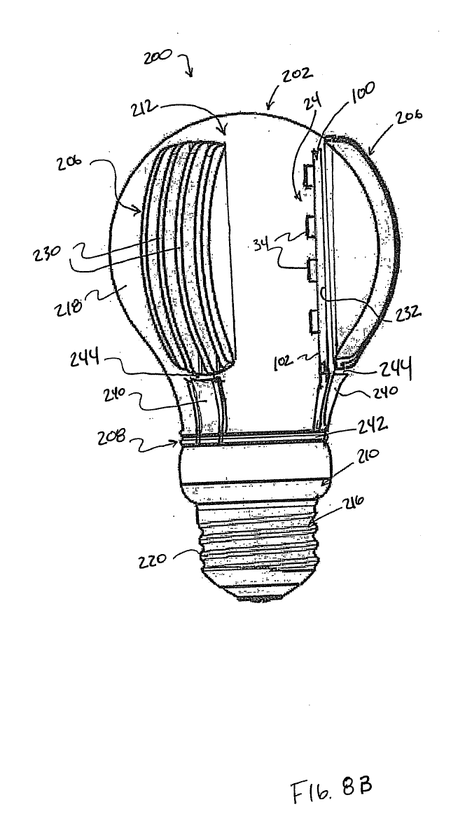

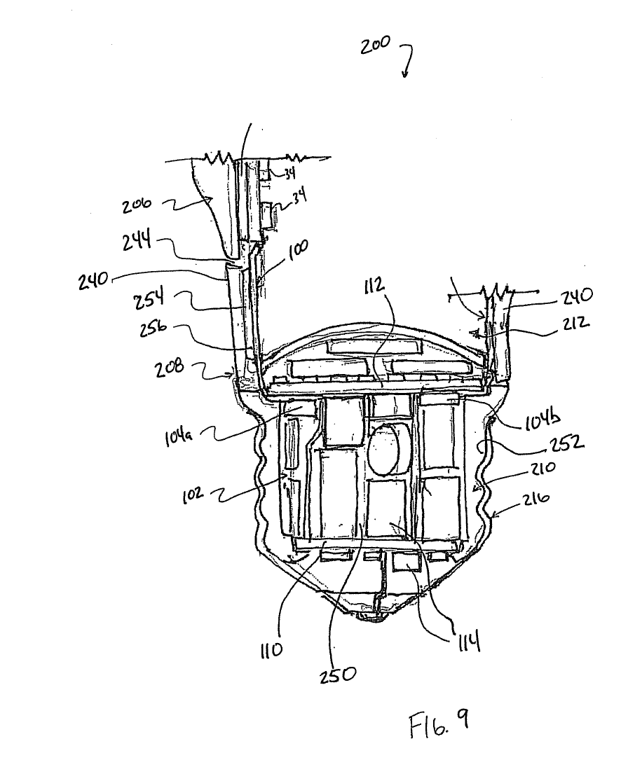

Another LED light bulb device 200 in accordance with principles of the present disclosure is shown in FIGS. 7-8B. As a point of reference, FIG. 8A illustrates the device 200 slightly rotated from the orientation of FIG. 7, whereas FIG. 8B shows the device 200 from the same vantage point as FIG. 8A, but with several internal components (described below) visible. The device 200 includes a light bulb-like structure 202, the LED assembly 24 as described above (referenced generally in FIG. 8B), one or more LED heatsinks 206, a power conversion heatsink 208, and an insulator sleeve 210. Details on the various components are provided below. In general terms, however, the light bulb-like structure 202 includes a bulb body 212, and the LED assembly 24 provides one or more of the light emitting diodes (LEDs) 34 as described above (several of which are illustrated in FIG. 8B so as to be visible “through” the bulb body 212 for ease of understanding). The LED assembly 24 is mounted to the light bulb-like structure 202. The LED heatsink(s) 206 and the power conversion heatsink 208 are provided apart from one another, and collectively define a heat transfer assembly for the device 200. The LED heatsink(s) 206 transfer heat generated by the LEDs 34, whereas the power conversion heatsink 208 transfers heat generated by other high operational temperature components (e.g., power conversion electrical components) of the LED assembly 24 as described below. The LED light bulb device 200 emits light when connected to, and energized by, a standard light bulb socket or fixture.

The light bulb-like structure 202 is akin to a “standard” or known AC bulb (e.g., an Edison light bulb) and includes the bulb body 212 and an optional base 216. The bulb body 212 can be formed of glass, plastic (e.g., clear glass or plastic), etc., and includes a wall 218 defining an interior region. The bulb body 212 can have various shapes and sizes (e.g., pear shape (A19), rounded globe, pyramidal (flood light) candle-shaped, etc.), as well as other optional features that allow a more integrated appearance of the mounted LED heatsinks 206. In some constructions, the bulb body wall 218 can be continuous, effectively enclosing the interior region. In other embodiments, the wall 218 can form slots through a thickness thereof and within which selected ones of the LEDs 34 are disposed as described above.

Where provided, the base 216 is akin to a conventional light bulb base, and has a threaded exterior surface 220 for engaging a standard threaded AC light socket or fixture to hold and power the LED light bulb device 200 to the AC light socket or fixture as is known in the art. Along these same lines, the base 216 is optionally formed from a conductive material (e.g., metal) with other connection standards as are typically employed with conventional light bulbs.

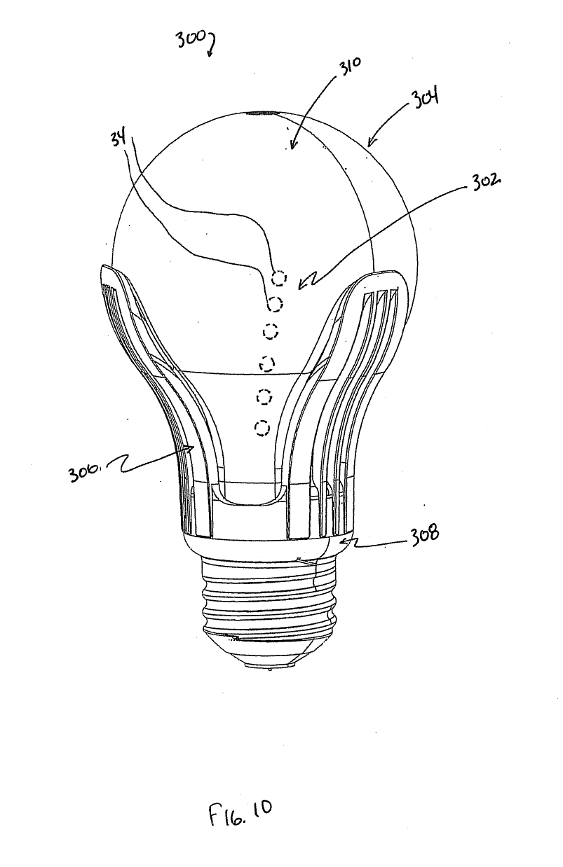

With reference to FIGS. 8B and 9, the LED assembly 24 is in accord with the descriptions above and includes, in some embodiments, a plurality of the LEDs 34, the substrate strips 100, and the circuitry 102 (referenced generally). The substrate strips 100 each maintain a set of the LEDs 34, and are coupled to the circuitry 102 to establish an electrical pathway for powering of the LEDs 34.

Returning to FIGS. 7-8B, the LED heatsinks 206 are configured to dissipate heat from corresponding ones of the LEDs 34, and to support corresponding ones of the substrate strips 100 relative to the bulb body 212. The number of LED heatsinks 206 corresponds with the number of substrate strips 100; thus, in the one example shown, three substrates strips 100 (one of which is shown in FIG. 8B) are provided, and thus three of the LED heatsinks 206 are included. Any other number, greater or lesser than three, is also acceptable. The LED heatsinks 206 can be identical in terms of material and design, and can be formed of an appropriate heatsink material (e.g., metal, molded plastic, ceramic, etc.). Each of the LED heatsinks 206 can incorporate or form fins 230 or pegs (not shown) that promote heat dissipation. In some embodiments, a trailing face 232 of each of the LED heat sinks 206 (identified in FIG. 8B) is relatively flat for receiving the corresponding substrate strip 100 (e.g., a pressure sensitive adhesive bonds the substrate strip 100 to the trailing face 232). In other embodiments, the trailing face 232 can form a trough configured for passage of a respective one of the substrate strips 100.

The power conversion heatsink 208 is separate from the LED heatsinks 206, and is made of an appropriate heat sink material (e.g., metal, molded plastic, ceramic, etc.). In some embodiments, the power conversion heatsink 208 includes legs 240 and a base 242. The legs 240 are connected at the base 242, and the number of legs 240 corresponds with the number of substrate strips 100 (thus, in the one embodiment shown, three of the legs 240 are provided). The base 242 can have a ring-like shape for assembly to the bulb-like structure 202. Taken in combination, the legs 240 and the base 242 are sized and shaped such that upon final assembly, a gap 244 is defined between each of the legs 240 and a corresponding one of the LED heat sinks 206 for reasons made clear below.

As best shown in FIG. 9, the insulator sleeve 210 is formed of an electrically non-conductive material, and is configured for mounting to the power conversion heatsink 208, and forms a channel 250 sized to encase a bulk of the circuitry 102. The insulator sleeve 210 is formed of an electrically non-conductive material, and can be mounted about the circuitry 102 during assembly with the power conversion heatsink 208. The insulator sleeve 210 has a threaded exterior surface 252 that threads into the interior surface of base 216.

FIG. 9 illustrates a portion of the LED light bulb device 200 upon final assembly. In general terms, the insulator sleeve 210 encloses the circuitry 102 relative to the power converting board 112, and is mounted to the power conversion heatsink 208. The power conversion heatsink 208 is, in turn, mounted to the bulb body 212 (e.g., via an adhesive sealant) in the location shown. The substrate strips 100 extend from the power converting board 112, and extend relative to the bulb body 212. In this regard, a heat dissipation layer 254 can be assembled to respective ones of the substrate strips 100 (e.g., via a pressure sensitive adhesive 256) adjacent the power conversion heatsink 208. Regardless, the high operating temperature power transforming or converting components 104a, 104b are located immediately adjacent the power converting board 112, and thus in close proximity to the power conversion heatsink 208. Thus, the relatively high heat generated during operation of the power converting board 112 and associated power transforming components 104a, 104b is readily transferred to, and dissipated by, the power conversion heatsink 208. Remaining components of the circuitry 102 are strategically located at other locations within the channel 250; because the components generate less heat (as compared to the power converting components 104a, 104b), heat dissipation issues, if any, are of minimal concern. Notably, the legs 240 extend over and along a portion of corresponding one of the substrate strips 100 to a location slightly spaced from a corresponding one of the LED heatsinks 206, thus preventing a user from accidentally touching a circuitry trace carried by the substrate strips 100.

The LED heatsinks 206 are located in close proximity to a respective ones of the substrate strips 100 (and thus relative to the LEDs 34 carried thereby), and can be mounted to the bulb body 212 in various manners (e.g., via a pressure sensitive adhesive 258). Thus, heat generated by the LEDs 34 is readily transferred to, and dissipated by, the corresponding LED heatsink 206. Notably, the LED heatsinks 206 are separated from the corresponding power conversion heatsink leg 240 by the gap 244. Alternatively, a spacer made of low thermal transfer material can be inserted in the gap 244 to further insulate the corresponding substrate strip 100 (and any circuitry trace carried thereby) from possible user contact. Regardless, by physically separating the LED heatsinks 206 from the power conversion heatsink 208, thermal transfer between the heatsinks 206, 208, if any, is limited.

The LEDs 34 are arranged relative to the bulb body 212 so as to direct emitted light toward the bulb body 212 interior. The bulb body wall 218 can have any of the formats described above (e.g., open or closed slots), with a light path from each of the LEDs 34 going into the bulb body 212 interior region and then outwardly from the interior region.

The separate LED heatsinks 206 effectively “float” along the fattest part of the common bulb body shape 212 and as such the heat convection can be: larger by being located in the widest part of the bulb body 212; improve convection in an up or down application with full and direct pass-through airspace; improve heat dissipation by dividing the LEDs 34 into groups and spacing them remotely from each other; permit two different levels of heatsink temperatures by isolating the LEDs 34 from the power converting parts 104a, 104b with different heat dissipation paths and the separation gap 244.

The power conversion heatsink 208, and in particular the legs 240, combine with other components as protection for LED connector wiring. One version of the device 200 of the present disclosure invention places the hottest of the power converting parts (i.e. MOSFET and inductors) on their own flexible substrate to provide a widened path to specific zones of the power conversion heatsink 208. This may be combined with the LED connector wiring as a separate layer of the flex circuitry 102. This is applied using the pressure sensitive adhesive 254 or similar material that permits heat penetration while protecting the circuit from power transfer so the UL high-pot test can be achieved.

The gap 244 between the separated heatsinks 206, 208 can be either insert molded with a non-heat or very low heat non-conductive separator segment or a placement of the heatsinks 206, 208 to form the gap 244.

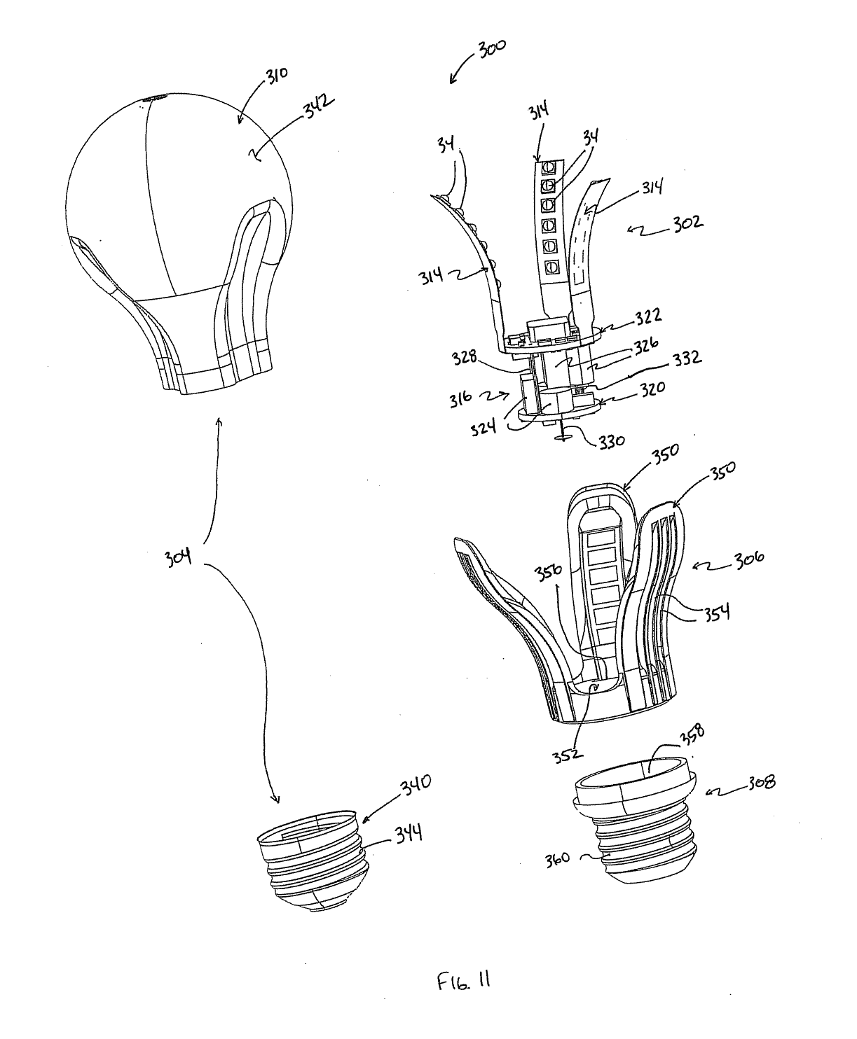

Another embodiment of an LED light bulb device 300 in accordance with principles of the present disclosure is shown in FIG. 10. The device 300 includes an LED assembly 302 (referenced generally), a light bulb-like structure 304, a heatsink frame 306, and an insulator sleeve 308. Details on the various components are provided below. In general terms, however, the light bulb-like structure 304 includes a bulb body 310, and the LED assembly 302 provides one or more of the LEDs 34 as described above (several of which are illustrated with dashed lines in FIG. 10 so as to be visible “through” the bulb body 310 for ease of understanding). The LED assembly 302 is mounted to the light bulb-like structure 304, for example via the heatsink frame 306 and/or the insulator sleeve 304. The LED light bulb device 300 emits light when connected to, and energized by, a standard light bulb socket or fixture.

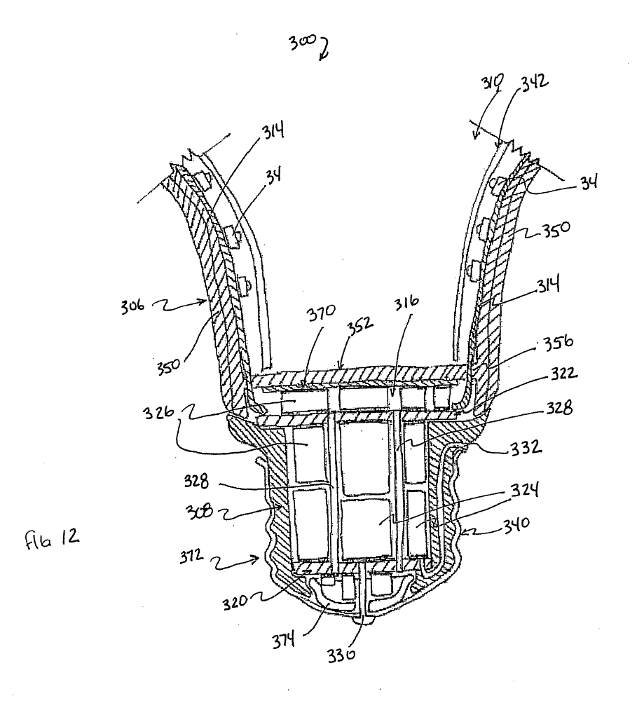

With reference to FIG. 11, the LED assembly 22 includes, in some embodiments, a plurality of the LEDs 34, substrate strips 314, and circuitry 316 (referenced generally). The substrate strips 314 each maintain a set of the LEDs 34, and are coupled to the circuitry 316 as described below to establish an electrical pathway for powering of the LEDs 34.

In some constructions, the substrate strips 314 are each a flexible, non-conductive material akin to flex circuits as known in the art, and carry circuitry traces to each of the LEDs 34 formed thereon. Alternatively, a more rigid material can be employed for some or all of the substrate strips 314.

The circuitry 316 can assume a wide variety of forms appropriate for converting AC energy (e.g., 120 volts) to DC energy appropriate for energizing the LEDs 34; or where the LEDs 34 are configured to operate based on an AC power input, the circuitry 316 can incorporate components configured to transform a provided AC power supply to an AC power format appropriate for powering the LEDs 34.

With the above in mind, in some constructions, the circuitry 316 includes a first or filtering board 320 and a second or power converting board 322. The boards 320, 322 can each be a rigid or flexible printed circuitry board having or forming various circuitry traces. Electrical power filtering components 324 (referenced generally) are mounted and electrically connected to the filtering board 320, and are configured to filter delivered power and/or other related functions before relaying appropriate power to the power converting board 322 as is known in the art. Power converting or transforming electrical components 326 (referenced generally) are mounted and electrically connected to the power converting board 322, and are configured to modify AC power to DC power and/or otherwise perform related power modification functions as may be desired or required to drive the LEDs 34 as is known in the art.

The filtering board 320 and the power converting board 322 are sized and shaped for nested assembly within the insulator sleeve 308 in a spaced apart, physically separated fashion as described below, and thus can have the circular perimeter shape shown. One or more connector wires 328 electrically connect the filtering board 320 with the power converting board 322, delivering filtered power to the power converting board 322. A hot wire 330 and a neutral wire 332 (partially hidden in the view of FIG. 11) are also connected to the filtering board 320 for reasons made clear below.

The light bulb-like structure 304 is akin to a “standard” or known AC bulb (e.g., an Edison light bulb) and includes the bulb body 310 and a base 340. The bulb body 310 can be formed of glass, plastic (e.g., clear glass or plastic), etc., and includes a wall 342 defining an interior region. The bulb body 310 can have various shapes and sizes (e.g., pear shape (A19), rounded globe, pyramidal (flood light) candle-shaped, etc.), as well as other optional features that allow a more integrated appearance of the mounted heatsink frame 306. The base 340 is akin to a conventional light bulb base, and has a threaded exterior surface 344 for engaging a standard threaded AC light socket or fixture to hold and power the LED light bulb device 300 to the AC light socket or fixture as is known in the art. Along these same lines, the base 340 is optionally formed from a conductive material (e.g., metal) as is typically employed with conventional light bulbs.

The heatsink frame 306 is configured to support the substrate strips 314 (and thus the corresponding LEDs 34) relative to the bulb body 310, and dissipate heat. The heatsink frame 306 is formed of an appropriate heatsink material (e.g., metal, molded plastic, ceramic, etc.). The heatsink frame 306 includes or forms legs 350 and may include a platform 352. The number of legs 350 corresponds with the number of substrate strips 314, and can each incorporate or form fins 354 or pegs (not shown) that promote heat dissipation. The platform 352 is centrally disposed within the legs 352, and forms slots 356 (one of which is visible in the view of FIG. 11) configured for passage of a respective one of the substrate strips 314 as described below. Alternatively, the platform 352 element may be a discrete part, assembled to heatsink frame 306 and or to the power converting board 322.

The insulator sleeve 308 is formed of an electrically non-conductive material, and is configured for mounting to the heatsink frame 306, and forms a channel 358 sized to encase a bulk of the circuitry 316. The insulator sleeve 308 is formed of an electrically non-conductive material, and can be formed about the circuitry 316 during assembly with the heatsink frame 306. The insulator sleeve 308 has a threaded exterior surface 360 that threads into the interior surface of the base 340.

FIG. 12 illustrates a portion of the LED light bulb device 300 upon final assembly. In general terms, the insulator sleeve 308 encloses the circuitry 316 relative to the platform 352, and is mounted to the heatsink frame 306. The substrate strips 314 extend from the power converting board 322, through a corresponding one of the slots 356 in the platform 352, and extend along the bulb body 310. The arms 350 of the heatsink frame 306 are located in close proximity to the LEDs 34, with the LEDs 34 being located relative to the bulb body wall 342 so as to direct emitted light toward the bulb body 310 interior. The power converting board 322 is located in close proximity to the platform 352, with one or more of the components 326 mounted to the power converting board 322 being connected to the platform 352 by heat transfer tape 370 or other structures. With this arrangement, the heat generated by operation of the power converting board 322 and associated power converting components 326 is readily transferred to, and dissipated by, the heatsink frame 306. Conversely, the filtering board 320 is spaced from the power converting board 322 (as well as the heatsink frame 306). Because operation of the filtering board 320 and corresponding electrical filtering components 324 generates little heat, heat dissipation relative to the filtering board 320 is of minimal concern. The base 340 is assembled over the insulator sleeve 308 as shown, with the hot wire 330 projecting through the base 340. The base 340 and the insulator sleeve 308 collectively define a base unit 372 that maintains the circuitry 316. The neutral wire 332 passes through the insulator sleeve 308, and is exposed for soldering connection to the base 340 at an exterior thereof. With this construction, upon threaded insertion of the base 340 within a conventional light bulb socket or fixture, necessary electrical connections are made at the hot wire 330 and the neutral wire 332. An insulator 374 is provided within the base unit 372 to electrically isolate the hot wire 330.

With the above construction, the LED lamp driver circuitry 316 for filtering and converting AC to DC power will fit within or substantially within the confines of a common light bulb base 340 along with the internal electrical insulator sleeve 308. This is accomplished by using the two-board format (i.e., the physically separate filtering board 320 and power converting board 322) with a particular orientation and separation of components. The filtering board 320 is filter purposed and located to the power reception (via the hot wire 330 and the neutral wire 332); the power converting board 322 is configured to effectuate AC to DC power transforming, is located in close proximity to, and is thermally connected to the heatsink frame 306. The hot wire 330 and the neutral wire 332 carry current from a fixture socket. The contacts are wired through the base 340/insulator sleeve 308 to provide current to the filtering board 320 otherwise located closest to the base 340 and largely perpendicular to a centerline of the base 340. The filtering board 320 contains the mounted and electrically connected power filtering components 324 on both sides thereof, with the components 324 mounted to fit to the base 340/insulator sleeve 308 shape on one side, and to nest with components of the power converting board 322 on the other side. The power converting board 322 is generally located in parallel and concentric to the filtering board 320, with the both boards 320, 322 being largely circular to fit within the internal space of the insulator sleeve 308. The power transforming components 326 modify the power AC to DC and otherwise perform related power modification activities as may be desired or required to drive the LEDs 34.

The resulting board division (i.e., the separated filtering board 320 and power converting board 322) is purposed to benefit access to power by the filtering board 320 and heatsink requirements of the power converting board 322. Therefore, the heatsink frame 306 is “connected” to the power converting board 322 and/or the power converting components 326 for heat dissipation as required by the power converting components 326, and remotes the filtering board 320 with the filtering components 324 not otherwise requiring direct method heat dissipation yet places the filtering components 324 toward their purpose of filtering incoming power. The combination of this orientation and part division permits a more contained and nested solution to enhance the bulb body 310 interior “openness” for light emanation. The parts division permits the resulting two-board stacked solution to require only two wires (the hot wire 330 and the neutral wire 332) to power the filtering board 320, the two connector wires 348 between the filtering and power converting boards 320, 322, and two connections (not shown) to each of one or more of the LED circuits from the power converting board 322 where the power converting board 322 connections are ideally situated to the orientation of the LED mountings. The two-board 320, 322 structure, size, and orientation are more suitably contained to satisfy the requirements for high-pot testing as contained by the base 340, the insulator sleeve 308, the bulb body 310 enclosure, and the heatsink frame 306. The resulting segregated and oriented LED driver approach provides appropriate construction for automation, directly related purpose for each section toward electrical contacts, and elimination of obstructions within the bulb body 310 enclosure for maximum light emanation.

Although the present disclosure has been described with reference to preferred embodiments, workers skilled in the art will recognize that changes can be made in form and detail without departing from the spirit and scope of the present disclosure. For example, while the LED light bulb device has been described as orienting the LEDs “outside-in” (meaning the direction of the LED's aim) either outside the bulb enclosure exterior or along the outside of the bulb enclosure in a slot of the enclosure and nested therein, in other embodiments, the LEDs can face outwardly. The LEDs can be inwardly aiming at an angle to facilitate the “shortening” of heatsink shadowing. Further, LED light bulb devices in accordance with principles of the present disclosure can incorporate additional features such as coatings, films, fabrics, surfaces texturing, etc., that desirably affect or diffuse light emanating from the LEDs.

What is claimed is:

1. An LED light bulb device comprising:
a bulb body;
an LED assembly including a plurality of light emitting diode lights and circuitry, the circuitry including power converting components adapted to modify applied power for powering the light emitting diode lights via conductive wiring;
an LED heatsink mounted to the bulb body in close proximity to at least one of the light emitting diode lights; and
a power conversion heatsink provided apart from the LED heatsink and mounted to the bulb body in close proximity to at least one of the power conversion components.

2. The device of claim 1, wherein the power conversion heatsink forms a protective cover for the conductive wiring.

3. The device of claim 1, wherein the heatsinks are formed along the exterior of a common incandescent bulb shape.

4. The device of claim 1, wherein the circuitry includes a flexible substrate that commutes heat from at least one of the power converting components to the power conversion heatsink.

5. The device of claim 4, wherein the substrate is a circuit board forming at least one tab that contacts the power conversion heatsink.

6. The device of claim 1, wherein at least a majority of a mass of the LED heatsink is located in a widest portion of the bulb body.

7. The device of claim 1, further comprising a base assembled to the bulb body, and wherein the power conversion heatsink includes a ring disposed immediately adjacent the base.

8. The device of claim 1, wherein the heatsinks extend from a surface of the bulb body, and further wherein the bulb body has a common incandescent bulb enclosure shape.

9. The device of claim 1, wherein a surface area of the heatsinks is sized to provide necessary convection for dissipating expected component heat to maintain component temperature within specification.

10. The device of claim 1, further comprising a base assembled to the bulb body, wherein the power conversion components are located within the base.

11. The device of clam 10, wherein the circuitry further includes a first substrate board maintaining the power conversion components and a second substrate board maintaining filtering components, and further wherein the first substrate board is spaced from the second substrate board.

12. The device of claim 11, wherein the first substrate board is more proximate the bulb body than the second substrate board.

13. The device of claim 12, wherein heat generated at the first substrate board is directly conducted to the power conversion heatsink.

14. The device of claim 1, wherein the bulb body defines an open interior region, and further wherein at least one of the LEDs is aimed inward toward the interior of the bulb body.

15. The device of claim 14, wherein light from the at least one light emitting diode light is directed inwardly into the interior region and then outwardly from the interior region.

16. The device of claim 1, wherein the LEDs are mounted on one of a rigid substrate and a flexible substrate.

17. The device of claim 1, further comprising a plurality of LED heatsinks

18. The device of claim 1, wherein the LED heatsink is mounted at an exterior of the bulb body, and further wherein the bulb body exterior does not extend over the at least one light emitting diode light.

19. The device of claim 1, wherein the LED heatsink comprises a plastic with a coating of copper.
